(19) United States
(12) Patent Application Publication
(10) Pub. No.: US 2007/0151383 A1
(43) Pub. Date: Jul. 5, 2007

(54) Straddle-Type Vehicle

(75) Inventors: Shouichi Kubo, Shizuoka (JP); Takayuki Nobuhira, Shizuoka (JP)

Correspondence Address: HOGAN & HARTSON L.L.P., 1999 AVENUE OF THE STARS, SUITE 1400, LOS ANGELES, CA, 90067, US

(73) Assignees: YAMAHA HATSUDOKI KABUSHIKI KAISHA, Iwata-shi (JP); Yamaha Motor Co., Ltd.

(21) Appl. No.: 11/567,606

(22) Filed: Dec. 6, 2006

(30) Foreign Application Priority Data
Dec. 8, 2005 (JP) 2005-355468

(51) Int. Cl. F16H 59/04

(52) U.S. Cl. 74/473.3

(57) ABSTRACT

A straddle-type vehicle includes a rear arm connected pivotally at a front end to a vehicle body through a first connecting shaft and at a rear end to a rear wheel. A connecting member is connected pivotally at one end to the rear arm through a second connecting shaft. A link is connected pivotally to the vehicle body through a third connecting shaft and pivotally to a remaining other end of the connecting member through a fourth connecting shaft. A damper is connected pivotally at a lower end to the link through a fifth connecting shaft. A lower end of the damper is positioned below a plane A including central axes of the second connecting shaft and the fourth connecting shaft, which are positioned at both ends of the connecting member, in a fully extended state of the damper. The connecting member is curved downward to avoid interference with the damper in a fully extended state.

### RELATED APPLICATIONS

This application claims the benefit of priority under 35 USC 119 of Japanese patent application no. 2005-355468, filed on Dec. 8, 2005, which application is hereby incorporated by reference in its entirety.

### BACKGROUND OF THE INVENTION

1. Field of the Invention

The present invention relates to a straddle-type vehicle such as motorcycle, scooter, snowmobile or a buggy, and more particularly to a connecting member for connection of a link and a rear arm that is curved.

2. Description of Related Art

In some straddle-type vehicles, a damper, a rear arm, and a vehicle body are connected together through a link to suppress vibrations and heighten comfort during running. See, for example, JP-A-9-30476.

The link in JP-A-9-30476 is structured such that a connecting hole to a vehicle body side, a connecting hole to a rear arm, and a connecting hole to a damper are opened and are the same in dimension in a vehicle width direction. In addition, the link disclosed in JP-A-9-30476 uses a gently arcuate connecting member for connection between the link and the rear arm.

In JP-A-9-30476, the gently arcuate connecting member is positioned below a damper. Other members such as an air cleaner, etc. are generally positioned close to one another above the damper, so that the damper is desirably arranged to be relatively low.

In addition, when a damper is made short in order to ensure a space above the damper, it becomes correspondingly difficult to suppress vibrations during running, and comfort is decreased. When a link and a connecting member are shifted laterally of the damper in order to arrange the damper below, a corresponding bearing is needed and leads to an increase in cost.

### SUMMARY OF THE INVENTION

The invention overcomes these problems and provides a straddle-type vehicle, which restricts an increase in cost while ensuring a space above a damper.

In order to solve the problem, the invention provides a straddle-type vehicle comprising a rear arm connected pivotally at a front end thereof to a vehicle body through a first connecting shaft and at a rear end thereof to a rear wheel. A connecting member is connected pivotally at one end thereof to the rear arm through a second connecting shaft. A link is connected pivotally to the vehicle body through a third connecting shaft and pivotally to the remaining other end of the connecting member through a fourth connecting shaft. A damper is connected pivotally at a lower end thereof to the link through a fifth connecting shaft. A lower end of the damper is positioned below a plane including central axes of the second connecting shaft and the fourth connecting shaft, which are positioned at both ends of the connecting member, in a fully extended state of the damper. The connecting member is curved downward to avoid interference with the damper in the fully extended state.

The connecting member may include a curved portion curved at a smaller radius of curvature than a first distance from the second connecting shaft positioned at one end thereof to the fourth connecting shaft positioned at the other end thereof. The connecting member may extend substantially vertically downward over the curved portion from the second connecting shaft in a fully extended state of the damper to extend substantially horizontally forward from the curved portion to the fourth connecting shaft.

Preferably, a width, as viewed in side view, of the connecting member in an intermediate position between the second connecting shaft and the fourth connecting shaft, which shafts are positioned at both ends of the connecting member, is larger than widths, as viewed in side view, of the second connecting shaft and the fourth connecting shaft.

Preferably, in a fully extended state of the damper, a first distance from the second connecting shaft to the fourth connecting shaft on the connecting member is equal to or larger than two times a second distance from the fourth connecting shaft to the fifth connecting shaft on the link.

Preferably, a second distance from the fourth connecting shaft to the fifth connecting shaft on the link is larger than a third distance from the third connecting shaft to the fourth connecting shaft on the link.

Preferably, a third distance from the third connecting shaft to the fourth connecting shaft on the link is smaller than a fourth distance from the first connecting shaft to the third connecting shaft on the vehicle body.

Preferably, a second distance from the fourth connecting shaft to the fifth connecting shaft on the link is smaller than a fourth distance from the first connecting shaft to the third connecting shaft on the vehicle body.

According to the invention, a lower end of the damper in a fully extended state is positioned below a plane including central axes of the second connecting shaft (toward the rear arm) and the fourth connecting shaft (toward the link), which are positioned at both ends of the connecting member, and the connecting member is curved downward so as to avoid an interference with the damper. Since a surplus cost as in the case where the connecting member is shifted laterally of the damper is not charged even when a space above the damper is ensured by arranging the damper below a plane including central axes of the two connecting shafts on the connecting member, it is possible to limit increase in cost while ensuring a space above the damper.

Other features and advantages of the invention will be apparent from the following detailed description, taken in conjunction with the accompanying drawings which illustrate, by way of example, various features of embodiments of the invention.

### BRIEF DESCRIPTION OF THE DRAWINGS

FIG. 1 is a side view showing a motorcycle according to an embodiment of the invention.

FIG. 2 is a side view showing an essential part of the motorcycle.

FIG. 3 is a cross sectional view taken along the line III-III in FIG. 2.

### DETAILED DESCRIPTION OF THE INVENTION

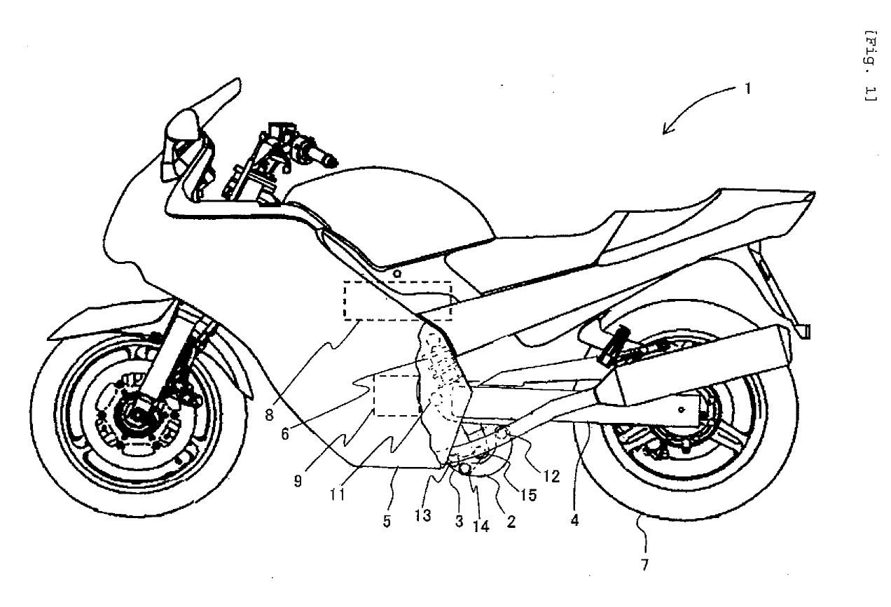

A motorcycle according to an embodiment of the invention is described below with reference to the drawings. FIG. 1 is a side view showing a motorcycle 1 according to an embodiment of the invention.

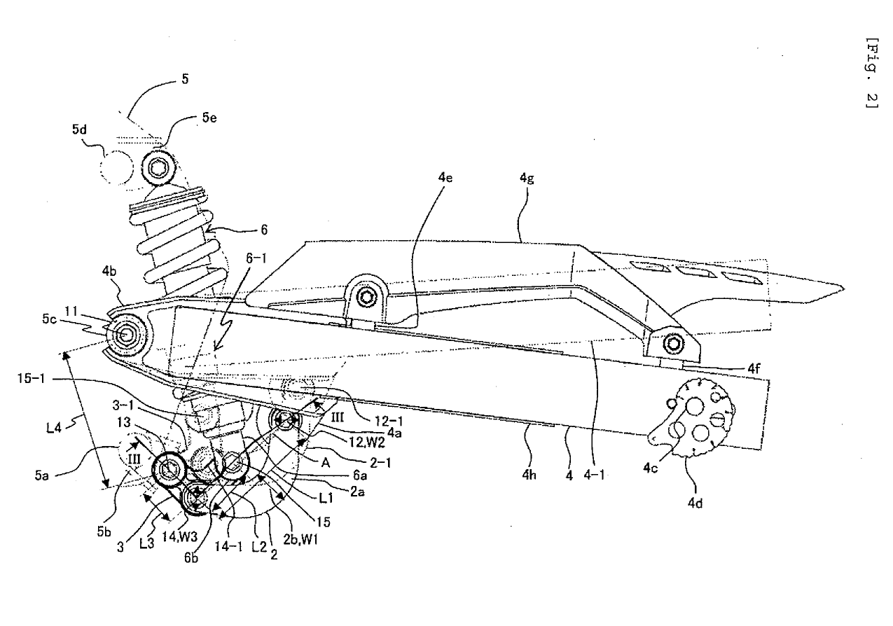

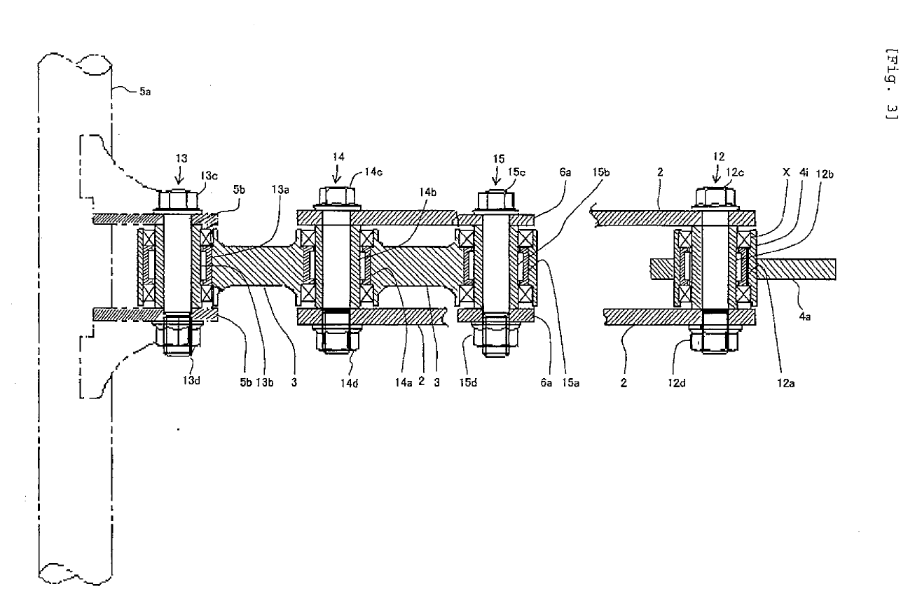

Motorcycle 1 includes a rear arm 4, a frame 5 and a damper 6 connected together by connecting members 2 and a link 3. As described with reference to FIGS. 2 and 3, the connecting members 2 are connected pivotally to the rear arms 4 through a second connecting shaft 12. The link 3 is connected pivotally to the connecting member 2 through a fourth connecting shaft 14 and pivotally to the frame 5 through a third connecting shaft 13.

The rear arm 4 is connected pivotally at a front end thereof to the frame 5 through a first connecting shaft 11 and at a rear end thereof to a rear wheel 7. The damper 6 is connected at an upper end thereof to the frame 5 and pivotally at a lower end thereof to the link 3 through a fifth connecting shaft 15. An air cleaner 8 is arranged above the damper 6. An engine 9 is arranged forwardly of rear arm 4.

FIG. 2 is a side view showing an essential part of motorcycle 1. FIG. 3 is a cross sectional view taken along the line III-III in FIG. 2. Referring to FIGS. 2 and 3, a detailed explanation is given to the connecting members 2, the link 3, the rear arm 4, the frame 5, and the damper 6.

As shown in FIG. 2, each connecting member 2 comprises a central portion 2b made of a curved sheet metal, and is connected pivotally at one end thereof to a bracket portion 4a, which extends downward from the rear arm 4, through the second connecting shaft 12. The link 3 is substantially triangular-shaped (here, a V-shape having a long side) as viewed in side view. The link 3 is connected pivotally to a bracket portion 5b, which is arranged on a cross pipe 5a of the frame 5, through the third connecting shaft 13 and pivotally to the remaining other ends of the connecting members 2 through the fourth connecting shaft 14.

As shown in FIG. 3, connecting members 2 comprise a pair of left and right sheet metals, with the link 3 interposed therebetween. The bracket portion 5b comprises a pair of left and right bracket portions 5b. Therefore, the link 3 is connected in a manner to be interposed by the bracket portions 5b.

A boss portion 4b at a front end of the rear arm 4 is connected pivotally to the frame 5 through the first connecting shaft 11 (a cross pipe 5c) positioned above the third connecting shaft 13. A rear end of the rear arm 4 is connected at a connection hole 4c to the rear wheel 7. The rear arm 4 and the rear wheel 7 are connected to each other with a snail cam chain puller 4d outside the rear arm 4, so that connection of the rear arm 4 and the rear wheel 7 is made firm.

The rear arm 4 comprises a pair of left and right members. A chain case 4g is connected to chain case mounts 4e, 4f in two front and rear locations on an upper surface of the left rear arm 4. A cross pipe (not shown) supporting the pair of left and right rear arms 4 is arranged in the lower vicinity of the front chain case mount 4e. The rear arms 4 and the cross pipe are further firmly connected to each other by arm reinforcement portions 4h, which extend longitudinally of the rear arms 4.

An upper end of the damper 6 is connected pivotally to a bracket portion 5e arranged on a cross pipe 5d of the frame 5 positioned above the first connecting shaft 11. A link mount 6a formed on a lower end of the damper 6 is connected pivotally to the link 3 through the fifth connecting shaft 15. The link mount 6a is bifurcate such as substantially U-shaped or the like to be opened downward and connected to the link 3 in a manner to interpose the link 3 as shown in FIG. 3. Of course, the link mount 6a is not bifurcate in some cases where the link 3 is bifurcate or the like.

FIG. 2 illustrates a fully extended state, that is, at the time of a largest length of the damper 6 in a non-loaded state. Positions of the connecting members 2, the link 3, the rear arms 4, the damper 6, etc. when the damper 6 is shortest are shown by two-dot chain lines and designated as connecting members 2-1, link 3-1, rear arms 4-1, damper 6-1, etc.

A lower end 6b of the damper 6 in a fully extended state is positioned below a plane (broken line A) including central axes of the second connecting shaft 12 and the fourth connecting shaft 14, which are positioned at both ends of the connecting members 2. The connecting members 2 are curved downward to avoid interference with the damper 6 in a fully extended state. The lower end 6b of the damper 6 includes the link mount 6a, etc. as shown in FIG. 2.

The connecting members 2 include a curved portion 2a curved at a smaller radius of curvature than a first distance L1 from the second connecting shaft 12 to the fourth connecting shaft 14. The connecting members 2 extend substantially vertically downward over the curved portions 2a from the second connecting shaft 12 in a fully extended state of the damper 6 to extend substantially horizontally forward from the curved portions 2a to the fourth connecting shaft 14.

A width W1, as viewed in side view, of the connecting members 2 in intermediate positions 2b between the second connecting shaft 12 and the fourth connecting shaft 14 is larger than widths W2, W3, as viewed in side view, of the second connecting shaft 12 and the fourth connecting shaft 14.

In a fully extended state of the damper 6, the first distance L1 from the second connecting shaft 12 (toward the rear arm 4) to the fourth connecting shaft 14 (toward the link 3) on the connecting members 2 is equal to or larger than two times a second distance L2 from the fourth connecting shaft 14 (toward the connecting members 2) to the fifth connecting shaft 15 (toward the damper 6) on the link 3.

The second distance L2 is larger than a third distance L3 from the third connecting shaft 13 (toward the frame 5) to the fourth connecting shaft 14 (toward the connecting member 2) on the link 3. The third distance L3 is equal to or smaller than half of a fourth distance L4 from the first connecting shaft 11 (toward the rear arm 4) to the third connecting shaft 13 (toward the link 3) on the frame 5.

The second distance L2 is equal to or smaller than half of the fourth distance L4. Connection of the second connecting shaft 12, the third connecting shaft 13, the fourth connecting shaft 14, and the fifth connecting shaft 15 is described with reference to FIG. 3.

The pair of connecting members 2, 2 are connected rotatably at the second connecting shaft 12, which is a connection of the connecting members 2 and the rear arm, to a connecting hole portion 4i, which is formed on the bracket portion 4a of the rear arm, by a bearing 12a, a bush 12b, a flange bolt 12c, and flange nuts 12d. More specifically, the flange bolt 12c is extended through the bush 12b, which is inserted into the connecting hole portion 4i with the bearing 12a therebetween, whereby the connecting members 2, 2 are connected rotatably to the bracket portion 4a in a manner to interpose the bracket portion 4a therebetween. This way of connection is exemplary and it is of course possible to use another way of connection, for example, by the use of a bolt, nuts, washers, etc. in place of the flange bolt 12c and the flange nuts 12d.

The link 3 is likewise connected pivotally at the fourth connecting shaft 14 to the connecting members 2, 2 by a bearing 14a, a bush 14b, a flange bolt 14c, and flange nuts 14d.

The link 3 is connected pivotally at the third connecting shaft 13, which is a connection with the frame 5, to the pair of bracket portions 5b, 5b, which are arranged on the cross pipe 5a of the frame, likewise by a bearing 13a, a bush 13b, a flange bolt 13c, and flange nuts 13d.

The link mount 6a formed at the lower end of the damper is connected pivotally at the fifth connecting shaft 15 to the link 3 likewise by a bearing 16a, a bush 15b, a flange bolt 15c, and flange nuts 15d in a manner to interpose the link 3.

An explanation is now given to interlocking of the connecting members 2-1, the link 3-1, the rear arms 4-1, the damper 6-1, etc. shown in FIG. 2.

First, when a shock is applied to the rear wheel in running of the motorcycle 1 on a bad road, the rear arms 4-1 connected to the rear wheel turn upward about the first connecting shaft 11, which is a connection with the frame 5. As the rear arms 4-1 turn upward, the connecting members 2-1 connected to the rear arms 4-1 are moved upward.

As the connecting members 2-1 are moved upward, the fourth connecting shaft 14-1, which is a connection with the link 3-1, also moves upward and the link 3-1 turns upward about the third connecting shaft 13, which is a connection with the frame 5. As the link 3-1 turns upward, the fifth connecting shaft 15-1, which is a connection with the damper 6-1 of the link 3-1, is also moved upward, so that the damper 6 connected at an upper end thereof to the frame 5 is compressed to absorb a shock.

With the motorcycle 1 according to the embodiment, the lower end 6b of the damper 6 in a fully extended state is positioned below the plane A including the second connecting shaft 12 (toward the rear arm 4) and the fourth connecting shaft 14 (toward the link 3), which are positioned at both ends of the connecting members 2, and the connecting members 2 are curved downward so as to avoid an interference with the damper 6, whereby the following effects are produced. Since a surplus cost as in the case where the connecting members 2 are shifted laterally of the damper 6 is not charged even when a space for the air cleaner 8, etc. positioned above the damper 6 is ensured by arranging the damper 6 below the plane A, it is possible to minimize cost while ensuring a space above the damper 6.

Since the connecting members 2 are curved downward without being shifted laterally of the damper 6, it is possible to readily clamp the fifth connecting shaft 15, which connects between the damper 6 and the link 3, from laterally of the motorcycle 1. The connecting members 2 include a curved portion 2a curved at a smaller radius of curvature than the first distance L1 from the second connecting shaft 12 to the fourth connecting shaft 14, which shafts are positioned at both ends thereof, allowing arrangement of the damper 6 further below and further ensuring that space above the damper 6, in which the air cleaner 8 or the like is positioned.

The connecting members 2 extend substantially vertically downward over the curved portions 2a from the second connecting shaft 12 in a fully extended state of the damper 6 to extend substantially horizontally forward from the curved portions 2a to the fourth connecting shaft 14, permitting arrangement of the damper 6 further below and further ensuring a space above the damper 6.

Since a width W1, as viewed in side view, of the connecting members 2 in intermediate positions 2b between the second connecting shaft 12 and the fourth connecting shaft 14, which shafts are positioned at both ends thereof, is larger than widths W2, W3, as viewed in side view, of the second connecting shaft 12 and the fourth connecting shaft 14, the strength of the connecting members 2 is ensured even when the connecting members 2 are curved largely.

In the case where in a fully extended state of the damper 6, the first distance L1 from the second connecting shaft 12 (toward the rear arm 4) to the fourth connecting shaft 14 (toward the link 3) on the connecting members 2 is equal to or larger than two times the second distance L2 from the fourth connecting shaft 14 (toward the connecting members 2) to the fifth connecting shaft 15 (toward the damper 6) on the link 3, the damper 6 must be especially arranged above or laterally of the connecting members 2 because the damper 6 approaches the fourth connecting shaft 14, but it is possible to further effectively restrict an increase in cost while ensuring a space above the damper 6.

In the case where the second distance L2 is larger than the third distance L3 from the third connecting shaft 13 (toward the frame 5) to the fourth connecting shaft 14 (toward the connecting member 2) on the link 3, the damper 6 must be arranged, in particular, above or laterally of the connecting members 2 because the fourth connecting shaft 14 of the link 3 becomes close to the frame 5 (the fifth connecting shaft 15) and the connecting members 2 are positioned above, but it is possible to further effectively restrict an increase in cost while ensuring a space above the damper 6.

In the case where the third distance L3 is smaller than the fourth distance L4 from the first connecting shaft 11 (toward the rear arm 4) to the third connecting shaft 13 (toward the link 3) on the frame 5, preferably equal to or smaller than a half thereof, the damper 6 must be arranged, in particular, above or laterally of the connecting members 2 because the link 3 becomes small in a space between the frame 5 and the connecting members 2 to make the connecting members 2 and the damper 6 liable to interfere with each other, but it is possible to further effectively restrict an increase in cost while ensuring a space above the damper 6.

In the case where the second distance L2 is smaller than the fourth distance L4, preferably equal to or smaller than a half thereof, the damper 6 must be arranged, in particular, above or laterally of the connecting members 2 because the fifth connecting shaft 15, which is a connection with the damper 6 of the link 3, becomes close to the connecting members 2 relative to a space between the frame 5 and the link 3, but it is possible to further effectively restrict an increase in cost while ensuring a space above the damper 6.

According to the embodiment, the connecting member 2 comprises a pair of left and right connecting members 2. However, the motorcycle 1 according to the embodiment is only exemplary and the invention has a feature in that the connecting member 2 is curved to avoid an interference with the damper 6. Therefore, connecting member 2 may alternatively not comprise a pair of left and right connecting members 2.

A vehicle body in the invention is not limited to the frame 5 but includes the engine 9 shown in FIG. 1. Thus, a position, to which the rear arm 4 or the like is connected, is not limited to the frame 5. Further, the connecting member according to the invention is not limited to a shape of the connecting member 2, the positional relationship of the first to fifth connecting shafts, etc., which are merely exemplary.

The particular embodiments of the invention described in this document should be considered illustrative, rather than restrictive. Modification to the described embodiments may be made without departing from the spirit of the invention as defined by the following claims.

1. A straddle-type vehicle comprising
a rear arm connected pivotally at a front end thereof to a vehicle body through a first connecting shaft and at a rear end thereof to a rear wheel,
a connecting member connected pivotally at one end thereof to the rear arm through a second connecting shaft,
a link connected pivotally to the vehicle body through a third connecting shaft and pivotally to the remaining other end of the connecting member through a fourth connecting shaft, and a damper connected pivotally at a lower end thereof to the link through a fifth connecting shaft, and
wherein a lower end of the damper is positioned below a plane including central axes of the second connecting shaft and the fourth connecting shaft, which are positioned at both ends of the connecting member, in a fully extended state of the damper and
the connecting member is curved downward to avoid interference with the damper in the fully extended state.

2. The straddle-type vehicle according to claim 1, wherein the connecting member includes a curved portion curved at a smaller radius of curvature than a first distance from the second connecting shaft positioned at one end thereof to the fourth connecting shaft positioned at the other end thereof.

3. The straddle-type vehicle according to claim 2, wherein the connecting member extends substantially vertically downward over the curved portion from the second connecting shaft in a fully extended state of the damper to extend substantially horizontally forward from the curved portion to the fourth connecting shaft.

4. The straddle-type vehicle according to claim 1, wherein a width, as viewed in side view, of the connecting member in an intermediate position between the second connecting shaft and the fourth connecting shaft, which shafts are positioned at both ends of the connecting member, is larger than widths, as viewed in side view, of the second connecting shaft and the fourth connecting shaft.

5. The straddle-type vehicle according to claim 1, wherein in a fully extended state of the damper, a first distance from the second connecting shaft to the fourth connecting shaft on the connecting member is equal to or larger than two times a second distance from the fourth connecting shaft to the fifth connecting shaft on the link.

6. The straddle-type vehicle according to claim 1, wherein a second distance from the fourth connecting shaft to the fifth connecting shaft on the link is larger than a third distance from the third connecting shaft to the fourth connecting shaft on the link.

7. The straddle-type vehicle according to claim 1, wherein a third distance from the third connecting shaft to the fourth connecting shaft on the link is smaller than a fourth distance from the first connecting shaft to the third connecting shaft on the vehicle body.

8. The straddle-type vehicle according to claim 1, wherein a second distance from the fourth connecting shaft to the fifth connecting shaft on the link is smaller than a fourth distance from the first connecting shaft to the third connecting shaft on the vehicle body.
